(19) United States
(12) Patent Application Publication
(10) Pub. No.: US 2004/0244816 A1
(43) Pub. Date: Dec. 9, 2004

(54) Cleaning machine and method for cleaning printed circuit board supporting trays

(76) Inventor: Yong Min Luo, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/625,239

(22) Filed: Jul. 22, 2003

(30) Foreign Application Priority Data
Jun. 3, 2003 (TW) 92210224

(51) Int. Cl. B08B 3/12

(52) U.S. Cl. 134/1; 134/18; 134/19; 134/26; 134/57 R; 134/95.2; 134/105; 134/186; 134/902

(57) ABSTRACT

A cleaning machine for cleaning supporting trays includes a cleaning cistern (100), a drying cabinet (200) and a control device (300). A water-supply pipe (112) and a drainpipe (120) are connected to the cleaning cistern. A microwave oven (118) is positioned in the cleaning cistern and a shelf (116) is located above the microwave oven for supporting the supporting trays. A cover (130) is pivotally attached to the cleaning cistern, under which a sensor is installed for sensing a level of water. The drying cabinet includes a shield (210) with a plurality of vents defined therein, and an intake fan (220) is provided in the shield. A plurality of heaters (232) is arranged in the drying cabinet below. One or more shelves (236) are mounted in the drying cabinet. An exhaust device (237) is connected to a back panel of the drying cabinet.

### BACKGROUND OF THE INVENTION

1. Field of the Invention

The present invention relates to a cleaning machine for cleaning printed circuit board (PCB) supporting trays, and particularly to an automatic and high efficiency cleaning machine with functions of cleaning and drying and a method for cleaning PCB supporting trays.

2. Description of the Related Art

For a typical modem computer system to operate properly and reliably, a PCB with good performance is required. In mass production of PCBs, waste solder often adheres to supporting trays that carry the PCBs along a conveyor line. If the supporting trays are used again and again without cleaning, the solder on the supporting trays is liable to randomly adhere to the PCBs, resulting in short circuits and other malfunctioning of the PCBs. Generally, the supporting trays are completely cleaned and dried every day in order to avoid this problem. These tasks may be performed manually or by using a cleaning machine. In either case, performance of these tasks relates not only to the cleaning and drying of the supporting trays themselves, but also to the consistent output of high quality PCBs.

When supporting trays are cleaned by hand, they are typically air dried thereafter. This tends to be slow and inefficient, and requires a good deal of valuable shop floor space. Moreover, if the supporting trays are not dried completely, residual water causes solder to splash and adhere to the PCBs.

P.R. China Patent Application No. 90202848.0 discloses one kind of cleaning machine. The cleaning machine comprises two chambers, a liquid spray chamber and a drying chamber. A plurality of tanks containing liquid is disposed in a top of the liquid spray chamber. The liquid comprises water and detergent. All the tanks are connected to a liquid cabinet via a pump. A water purification machine and a machine for changing workpieces' positions are located under the two chambers. A framework of the machine for changing workpieces' positions is set on a long axis of a wall of the chamber, and a trinal-cylinder orientation drive mechanism is provided at a top of the framework. Before the cleaning machine is started up, the user needs to thoroughly mix the detergent with the water.

However, the cleaning machine is applied in the production of large-scale mechanisms, and particularly to the mass production of products such as internal-combustion engines, motor vehicles etc. The cleaning machine is not directed to smaller-scale items such as PCB supporting trays. Furthermore, the cleaning machine is complex in structure, and adds to manufacturing costs commensurately.

Thus, an efficient cleaning machine suited to the art of computer hardware manufacture is desired.

### BRIEF SUMMARY OF THE INVENTION

Accordingly, an object of the present invention is to provide an automatic, high efficiency and low-cost cleaning machine with the functions of cleaning and drying.

Another object of the present invention is to provide a method for cleaning printed circuit board supporting trays.

To achieve the first above-mentioned object, a cleaning machine in accordance with a preferred embodiment of the present invention comprises a cleaning cistern, a drying cabinet, a control device and two pairs of casters. A water-supply pipe and a drainpipe respectively having an electromagnetic valve are connected to the cleaning cistern. A microwave oven is positioned in a bottom of the cleaning cistern, and a shelf is located above the microwave oven for supporting the supporting trays. A cover is pivotally attached to the cleaning cistern under which a sensor is installed for sensing a level of water in the cleaning cistern. The drying cabinet includes a shield with a plurality of vents defined therein, and an intake fan is provided in the shield. A plurality of heaters is arranged in a top of the drying cabinet below the shield. One or more shelves are mounted in the drying cabinet. An exhaust device is connected to a back panel of the drying cabinet. The cleaning process starts up automatically when the cleaning cistern is covered. After the cleaning process is completed, the user transfers the supporting trays to the drying cabinet, thereafter the supporting trays are dried via the control of the control device.

To achieve the second above-mentioned object, a method for cleaning and drying printed circuit board (PCB) supporting trays in a cleaning machine is provided. The cleaning machine comprises a cleaning cistern and a drying cabinet, and the method comprises the steps of: a) putting the supporting trays on a shelf in the cleaning cistern; b) performing a cleaning process; c) transferring the supporting trays to the drying cabinet after the cleaning process is completed; and d) performing a drying process.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is an exploded, isometric view of a cleaning machine in accordance with the preferred embodiment of the present invention;

FIG. 2 is an assembled view of FIG. 1;

FIG. 3 is a schematic diagram of a program logic control circuit of a cleaning cistern of the cleaning machine of FIG. 1;

FIG. 4 is a front elevation view of a control device of the cleaning machine of FIG. 1; and

FIG. 5 is a schematic diagram of a program logic control circuit of a drying cabinet of the cleaning machine of FIG. 1.

### DETAILED DESCRIPTION OF THE INVENTION

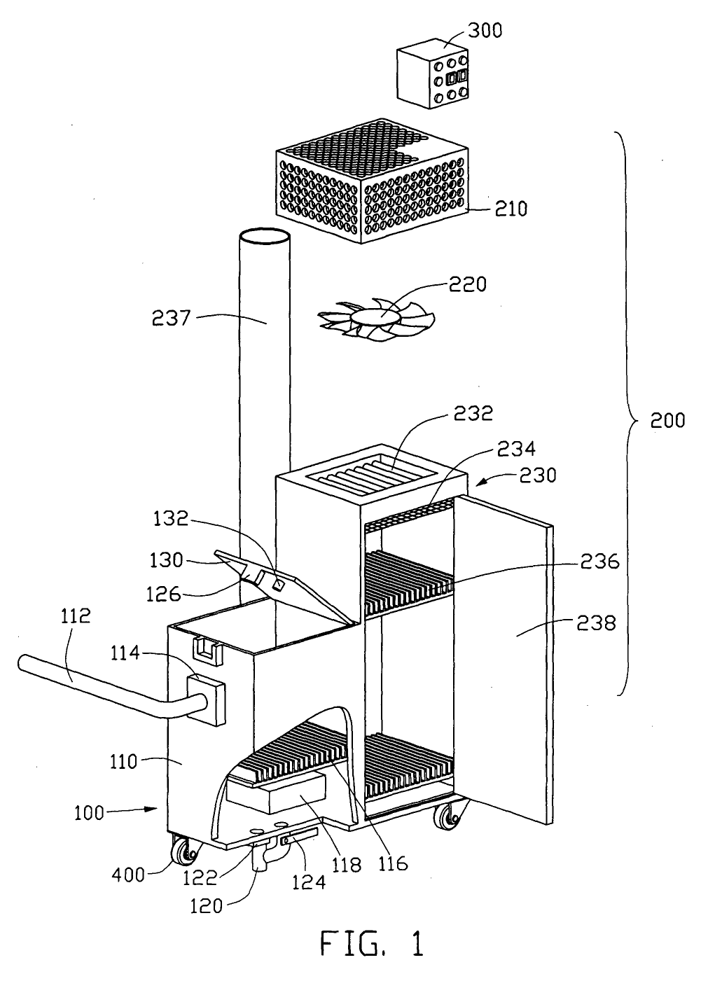

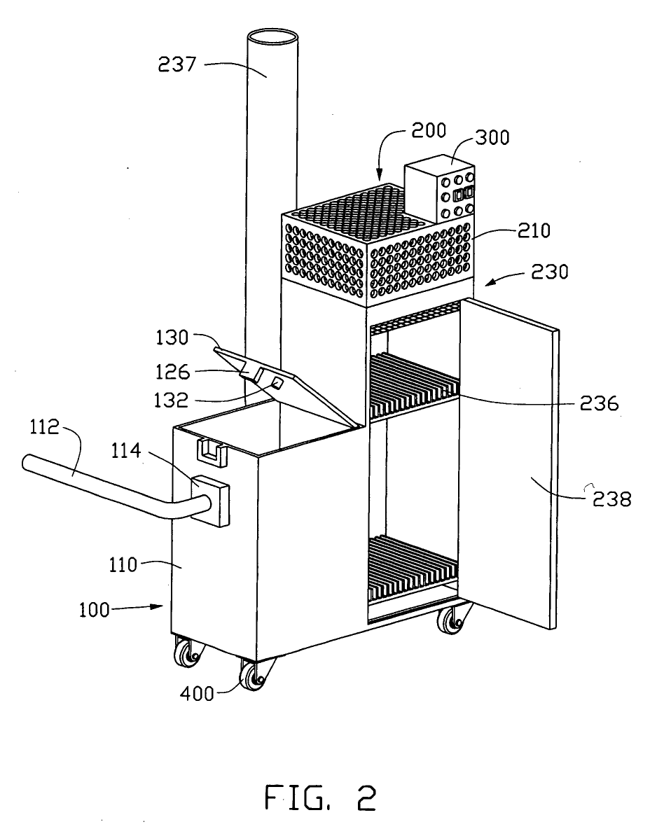

Referring to FIGS. 1 and 2, a cleaning machine in accordance with the preferred embodiment of the present invention comprises a cleaning cistern 100, a drying cabinet 200, a control device 300 and two pairs of casters 400.

The cleaning cistern 100 comprises a main body 110, and a cover 130 pivotally attached to the main body 110. The main body 110 comprises a microwave oven 118 and a shelf 116. The shelf 116 has a plurality of parallel ribs (not labeled), between which a plurality of PCB supporting trays (not shown) may be positioned. A water-supply pipe 112 and a water-supply electromagnetic valve 114 are provided on an outside of the main body 110. A drainpipe 120, a drain electromagnetic valve 122 and a hand valve 124 are provided on a bottom of the main body 110. A switch 126 is set on the cover 130. The switch 126 closes when the cleaning cistern 110 is covered by the cover 130, whereupon the water-supply electromagnetic valve 114 opens and water is fed into the cleaning cistern 100. A sensor 132 is installed on a bottom face of the cover 130, for sensing a level of water in the cleaning cistern 100. When the sensor 132 senses that the level of the water has reached a predetermined level, the supply of water is switched off. Thereafter the microwave oven 118 operates to clean the supporting trays on the shelf 116. After cleaning, the drain electromagnetic valve 122 opens, and the water drains from the cleaning cistern 100. When the power is off, a user can maintain the cleaning cistern 100 by opening the hand valve 124. A program logic control circuit controls the above cleaning process, and is described in detail below.

The drying cabinet 200 comprises a shield 210, an intake fan 220, and a frame 230. The shield 210 defines a plurality of vents (not labeled), and the intake fan 220 is provided in the shield 210. The frame 230 comprises a plurality of heaters 232, an adiabatic net 234, a plurality of shelves 236, an exhaust device 237, and a door 238. The heaters 232 are located in a top of the frame 230, and the adiabatic net 234 is provided below the heaters 232 so as to prevent the user from touching the heaters 232 and getting hurt. A hole (not shown) is defined in a back panel of the frame 230, with the exhaust device 237 connecting thereat. Accordingly, the drying cabinet 200 is continuously exhausted while being heated, which improves a drying speed of the supporting trays. The door 238 is pivotally attached to the frame 230. The control device 300 is attached on the shield 210, and controls the automatic cleaning process of the cleaning cistern 100 and automatic drying process of the drying cabinet 200. The control device 300 may alternatively be positioned elsewhere on or near the cleaning machine. A program logic control circuit controls the above drying process, and is described in detail below.

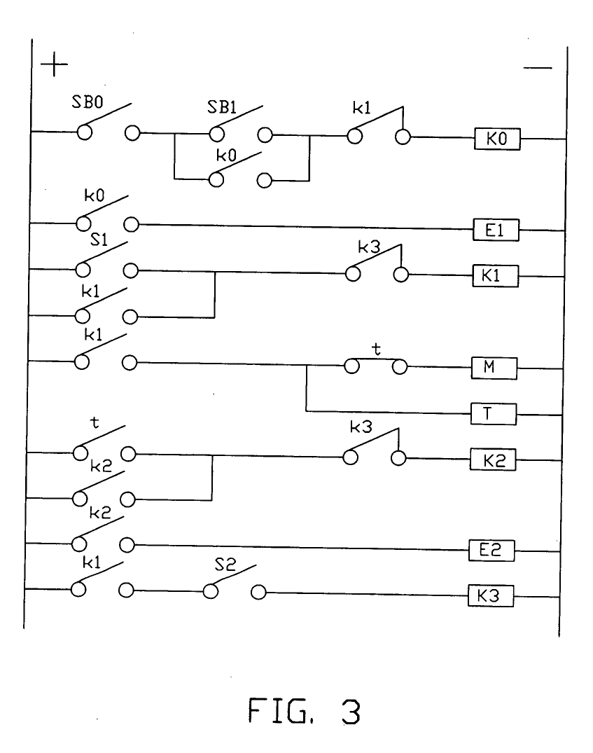

Referring to FIGS. 1 and 3, numerals and symbols of these two drawings have the following interrelationships. SB0 is a power-supply switch (not shown) of the cleaning cistern 100, SB1 is the switch 126, E1 is the water-supply electromagnetic valve 114, open switch S1 is connected to the sensor 132, M controls the microwave oven 118, T is a timer, E2 is the drain electromagnetic valve 122, open switch S2 is connected to a sensor (not shown) that senses drainage of water, and K0, K1 and K2 are relays used in the circuit. The operation of the cleaning cistern 100 is as follows. SB0 is pressed so that the cleaning cistern 100 is powered on. The cover 130 is rotated down to cover the main body 110, so that the switch SB1 is closed and thus the circuit is open. Then the relay K0 is electrified so that the open switch k0 is closed, which results in E1 being electrified. Thereafter the water-supply electromagnetic valve 114 opens to allow water to flow into the cleaning cistern 100. The open switch S1 closes when the sensor 132 senses that the water level has reached the predetermined depth, whereupon the relay K1 is electrified and the closed switch k1 opens. Accordingly, the relay K0 is powered off so that the switch k0 opens, which results in E1 being powered off and the water-supply electromagnetic valve 114 closing to switch off the water-supply. At the same time, M is powered on so that the microwave oven 118 begins to operate, and a timer T begins to time the operation of the microwave oven 118. The open switch t closes when a predetermined period of time has elapsed from the start of cleaning in the cleaning cistern 100. The relay K2 is then electrified so that the open switch k2 closes. Accordingly, the relay E2 is electrified so that the corresponding drain electromagnetic valve 122 opens to drain the water out of the cleaning cistern 100. When the water has drained out, the open switch S2 closes so that the relay K3 is electrified, whereupon the closed switch k3 is powered off. Accordingly, the whole circuit is powered off. That is, the automatic cleaning process of the cleaning cistern 100 is completed.

Referring to FIG. 4, the control device 300 is comprised in a box. The control device 300 comprises a reset button 310, a startup button 312, an intake fan switch 314, a power switch 316, a temperature controller 318, a time display 320, an alarm indicator light 322, a heat indicator light 324, and a time-out indicator light 326. The startup button 312 and the power switch 316 are provided to start the drying process. The fan switch 314 controls the intake fan 220. The temperature controller 318 displays and controls a temperature in the drying cabinet 200. The time display 320 displays a length of time of heating. The alarm indicator light 322 lights up while the temperature reaches a predetermined threshold. Pressing the reset button 310 can intermit the whole process.

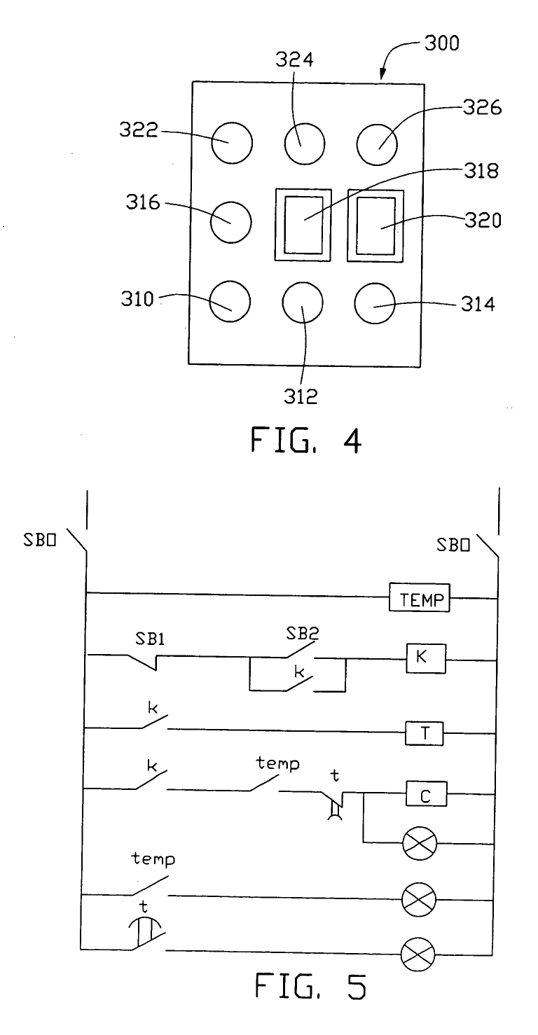

Referring to FIGS. 4 and 5, a program logic control circuit of the drying cistern 200 is provided. SB0 is the power switch 316, SB1 is the reset button 310, SB2 is the startup button 312, TEMP is the temperature controller 318, K is a relay, T is a timer (not shown), C controls the heaters 232, and the other items are the indicator lights such as the alarm indicator light 322, the heat indicator light 324 and the time-out indicator light 326. SB0 and SB2 are pressed so that the circuit is powered on and TEMP begins to control the temperature. At the same time, the relay K is electrified such that the three open switches k close. When the temperature reaches a predetermined temperature threshold, the two open switches temp close. Accordingly, C is electrified, and the timer T begins to time the drying process. When a predetermined time has elapsed, the closed switch t opens and C is powered off to stop the heating. Pressing SB1 can stop the whole drying process.

Operation of the cleaning machine is as follows. In the cleaning process, the supporting trays are firstly put on the shelf 116 in the cleaning cistern 100. The cover 130 is rotated down to cover the main body 110 so as to close the switch 126, whereupon the circuit is powered on. The water-supply electromagnetic valve 114 is opened so that water is fed into in the cleaning cistern 100 via the water-supply pipe 112. When the sensor 132 senses that the water level has reached the predetermined depth, the water-supply electromagnetic valve 114 is closed so that the water supply is switched off. Thereafter the microwave oven 118 operates to clean the supporting trays. This cleaning step is carried out for the predetermined period of time. When the period of time has elapsed, the microwave oven 118 is powered off and said cleaning step is ended. At this time, the drain electromagnetic valve 122 is opened so that the water is drained out of the cleaning cistern 100 via the drainpipe 120. When the power is off, the water can be drained out by opening the hand valve 124. After the cleaning process is completed, the user transfers the supporting trays to the shelves 236 of the drying cabinet 200. The door 238 is closed, and the power switch 316 and the startup button 312 are pressed. When the intake fan switch 314 is pressed, the drying cabinet 200 begins the drying process. The temperature controller 318 initializes the temperature before the heaters 232 begin to heat up. At this time, the alarm indicator light 322 and the heat indicator light 324 light up. At the same time, the time display 320 begins to display the length of time of heating. The time-out indicator light 326 lights up when the predetermined length of time has elapsed. Then the intake fan switch 314 and the power switch 316 are both opened, so as to end the whole process of cleaning and drying. Pressing the reset button 310 can intermit the whole drying process.

In an alternative embodiment of the present invention, the microwave oven 118 can be replaced with a blade-type agitator.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A cleaning machine for cleaning and drying printed circuit board (PCB) supporting trays, the cleaning machine comprising:
a cleaning cistern comprising a main body and a cover covering the main body, the main body comprising a water-supply pipe, a drainpipe, a microwave oven located in a bottom of the cleaning cistern and at least one shelf located above the microwave oven for supporting the supporting trays;
a drying cabinet comprising a frame comprising a plurality of heaters and at least one shelf for supporting the PCB supporting trays; and
a control device controlling a cleaning process and a drying process of the cleaning machine,
wherein when the cover is rotated down to cover the main body the cleaning process starts, and after the cleaning process is completed the supporting trays are transferred to the shelves of the drying cabinet and the drying process starts.

2. The cleaning machine as claimed in claim 1, wherein a switch is set on the cover, and the cleaning process is started up based on closing of the switch.

3. The cleaning machine as claimed in claim 1, wherein a sensor is provided on a bottom face of the cover for sensing a level of water in the cleaning cistern, and when the sensor senses that the level of the water has reached a predetermined level the supply of water is switched off.

4. The cleaning machine as claimed in claim 1, wherein two electromagnetic valves are respectively provided on the water-supply pipe and the drainpipe so as to switch on water supply and draining via the control of the circuit.

5. The cleaning machine as claimed in claim 4, wherein a hand valve is provided on the drainpipe, and the hand valve can be opened to allow a user to maintain the cleaning cistern when the power is off.

6. The cleaning machine as claimed in claim 1, wherein the drying cabinet further comprises an intake fan aligned with the heaters.

7. The cleaning machine as claimed in claim 6, wherein the drying cabinet further comprises a shield mounted on a top of the frame, the intake fan is provided in the shield, and the shield defines a plurality of vents.

8. The cleaning machine as claimed in claim 1, wherein the drying cabinet further comprises an exhaust device provided in a back panel of the frame.

9. The cleaning machine as claimed in claim 1, wherein an adiabatic net is provided below the heaters in the drying cabinet so as to prevent a user from touching the heaters and getting hurt.

10. The cleaning machine as claimed in claim 1, wherein two pairs of casters are provided under the cleaning machine so as to facilitate movement of the cleaning machine.

11. A method for cleaning and drying printed circuit board (PCB) supporting trays in a cleaning machine, the cleaning machine comprising a cleaning cistern and a drying cabinet, the method comprising the steps of:
a): putting the supporting trays on a shelf in the cleaning cistern;
b): performing a cleaning process;
c): transferring the supporting trays to the drying cabinet after the cleaning process is completed; and
d): performing a drying process.

12. The method according to claim 11, wherein the cleaning cistern comprises a main body and a cover covering the main body, the main body comprises a water-supply pipe, a drainpipe, the shelf, and a microwave oven under the shelf.

13. The method according to claim 12, wherein step b) comprises:
rotating the cover down to cover the main body;
feeding water in to the cleaning cistern via the water-supply pipe;
powering on the microwave oven to start cleaning of the supporting trays; and
draining the water out of the cleaning cistern via the drainpipe after the supporting trays are cleaned.

14. The method according to claim 11, wherein the drying cabinet comprises a frame comprising a plurality of heaters and at least one shelf for supporting the supporting trays.

15. The method according to claim 14, wherein the drying cabinet further comprises an intake fan aligned with the heaters.

16. The method according to claim 14, wherein the drying cabinet further comprises an exhaust device provided in a back panel of the frame.

17. A cleaning machine for cleaning and drying used printed circuit board supporting trays, comprising:
a cleaning cistern comprising a main body and a cover removably covering the main body, the main body comprising a water-supply pipe, a drainpipe, and a microwave oven located in the cleaning cistern;
a drying cabinet comprising a frame with a plurality of heaters, and at least one fan located around an upper portion of the drying cabinet and enclosed in a vented shield; and
an exhaust pipe communicating with an interior of said drying cabinet.

18. The cleaning machine as claimed in claim 17, wherein said exhaust pipe extends upwardly above both said drying cabinet and said cleaning cistern.
